(19) United States
(12) Patent Application Publication
(10) Pub. No.: US 2024/0338382 A1
(43) Pub. Date: Oct. 10, 2024

(54) TECHNIQUES FOR REAL-TIME SYNCHRONIZATION OF METADATA

(71) Applicant: Rubrik, Inc., Palo Alto, CA (US)

(72) Inventors: Dhawal Upadhyay, Bangalore (IN); Shubham Tagra, Bangalore (IN); Akhilesh Krishnan, Sunnyvale, CA (US); Vijay Karthik, Santa Clara, CA (US); Akshay Agrawal, Bangalore (IN)

(21) Appl. No.: 18/296,738

(22) Filed: Apr. 6, 2023

(51) Int. Cl. G06F 16/27; G06F 16/2455

(52) U.S. Cl. CPC G06F 16/27; G06F 16/24568

(57) ABSTRACT

Methods, systems, and devices for data management are described. A destination data storage environment of a data management system may transmit, to a source data storage environment configured to run one or more applications, a request to synchronize metadata for the one or more applications from the source data storage environment to the destination data storage environment. In some examples, the request may include configuration information indicating one or more filtering parameters for filtering a data stream to identify a subset of a set of data records and start and stop times for pushing data to the destination data storage environment. The destination data storage environment may receive, from the source data storage environment, the subset of the set of data records based on the configuration information, where the subset of the set of data records are determined from a filtering operation at the source data storage environment.

### FIELD OF TECHNOLOGY

The present disclosure relates generally to data management, including techniques for real-time synchronization of metadata.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports techniques for real-time synchronization of metadata in accordance with aspects of the present disclosure.

FIG. 2 shows an example of a computing environment that supports techniques for real-time synchronization of metadata in accordance with aspects of the present disclosure.

FIG. 3 shows an example of a computing environment that supports techniques for real-time synchronization of metadata in accordance with aspects of the present disclosure.

FIG. 4 shows an example of a process flow that supports techniques for real-time synchronization of metadata in accordance with aspects of the present disclosure.

FIG. 5 shows a block diagram of an apparatus that supports techniques for real-time synchronization of metadata in accordance with aspects of the present disclosure.

FIG. 6 shows a block diagram of a real-time synchronization component that supports techniques for real-time synchronization of metadata in accordance with aspects of the present disclosure.

FIG. 7 shows a diagram of a system including a device that supports techniques for real-time synchronization of metadata in accordance with aspects of the present disclosure.

FIGS. 8 through 11 show flowcharts illustrating methods that support techniques for real-time synchronization of metadata in accordance with aspects of the present disclosure.

### DETAILED DESCRIPTION

A data management system (DMS) may include a distributed system (e.g., with multiple distributed nodes or clusters of nodes) to support performing data backup for databases. Such data backup may include running applications across multiple data centers and cloud environments. The metadata of such applications is stored at a source data storage environment. A destination data storage environment may be able to access metadata of applications running in a different source data storage environment. To access the metadata, the destination data storage environment can either fetch the metadata or cache the data locally. Caching the metadata of an application running in a different environment locally may often have performance advantages. Caching can either be pull-based where data from each data center is pulled periodically or push-based where every data center pushes the changes to the application as the changes take place. However, a pull-based model may suffer from the staleness of data between two pulls of the data. For instance, if there are changes to the data after a last pull, then the data stored in the destination data storage environment may not reflect those changes until a new pull of the data is initiated.

One or more aspects of the present disclosure provide for performing a push-based caching method, where metadata is periodically pushed to the destination data storage environment. With the push-based caching method, the DMS may be able to synchronize metadata across applications running in different data centers or cloud environments. In the example of a caching method, a single destination data storage environment may support multiple source data storage environments. The source data storage environment may track any insert/update/delete operations on the data tables (by leveraging the change data capture functionality). In some cases, the destination data storage environment may transmit a request for initiating a push-based caching method, where the source data storage environment may be configured to push updates to the destination data storage environment in near real-time. In some instances, the destination data storage environment may not need to log every change happening at the source data storage environment. To avoid receiving unnecessary data, the destination data storage environment may provide one or more filter conditions to the source data storage environment. For example, the destination data storage environment may specify certain column information, and may request a data push for corresponding rows if the column has changed. Thus, the push-based caching method described herein provides for near real-time access to changes in relevant metadata in the source data storage environment.

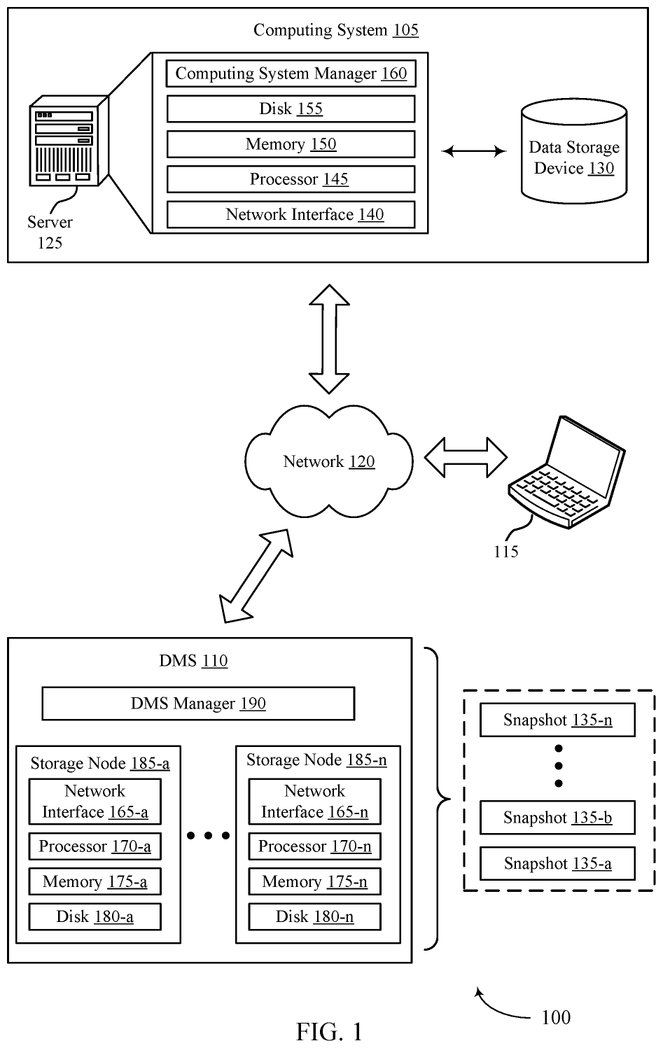

FIG. 1 illustrates an example of a computing environment 100 that supports techniques for real-time synchronization of metadata in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g. a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

A destination data storage environment of the DMS 110 may transmit, to a source data storage environment configured to run one or more applications, a request to synchronize metadata for the one or more applications from the source data storage environment to the destination data storage environment. In some examples, the destination data storage environment may be configured to locally cache the metadata for the one or more applications. The request may include configuration information indicating one or more filtering parameters for filtering a data stream including a set of data records at the source data storage environment to identify a subset of the set of data records and a start time and a stop time for pushing data to the destination data storage environment. The destination data storage environment of the DMS 110 may then receive, from the source data storage environment, the subset of the set of data records based on the configuration information. In some examples, the subset of the set of data records may be determined from a filtering operation of the data stream at the source data storage environment in accordance with the one or more filtering parameters.

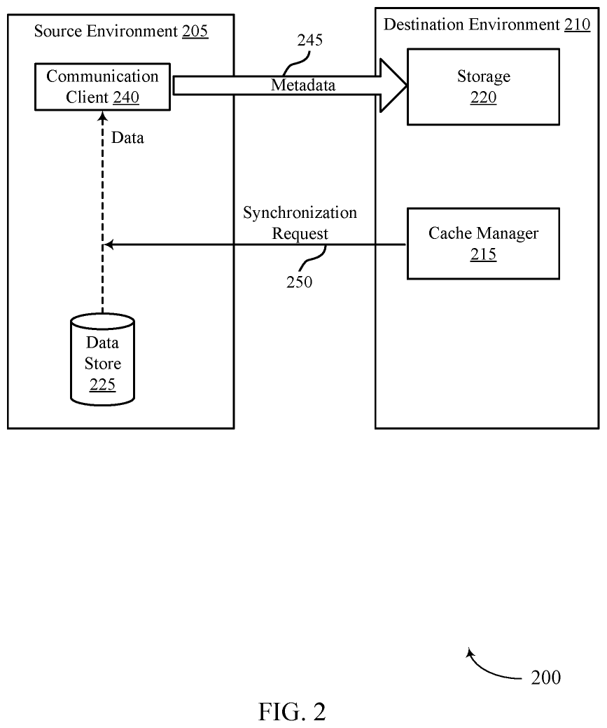

FIG. 2 shows an example of a computing environment 200 that supports techniques for real-time synchronization of metadata in accordance with aspects of the present disclosure. The computing environment 200 includes a source environment 205 and a destination environment 210. The source environment 205 and the destination environment 210 may be included in a DMS (e.g., DMS 110 of FIG. 1). At least a portion of the source environment 205 may be an example of a computing system 105 of FIG. 1. The source environment 205 may be an example of a host computing environment that supports an organization in data management, application execution, etc. For example, the source environment 205 may execute a set of virtual machines that support various applications, such as a web application, a database server, and/or an application server. The source environment 205 may also support access to a data store 225 that may store, manage, and provide access to organization data. The destination environment 210 may be used to support data management, backup, retention, and recovery procedures for one or more source computing environments, such as the source environment 205, as described herein.

The destination environment 210 may include a cache manager 215 that is configured to manage and activate backup procedures for various hosts, such as source environment 205. In some examples, backups may be scheduled on a source and a destination may be unaware of that source. After activation of such a data source, the destination may send a synchronization request. After transmitting the synchronization request, all changes may get automatically synchronized from source to destination, including any scheduled backups. For example, when a backup is scheduled or after activation by user, the cache manager 215 may transmit a synchronization request 250 to the source environment 205. Transmission of the synchronization request may be to access metadata for applications running on the source environment 205. The cache manager 215 may execute a backup script such as to read data from the data store 225 and communicate the data to the destination environment 210 for backup storage.

To perform near real-time caching of metadata, the computing environment 200 may support a push based model to synchronize metadata across applications running in different data centers or cloud environments. The source environment 205 and the destination environment 210 may communicate over a cloud platform. The cloud platform may offer an on-demand storage and computing services to user devices. In some cases, the source environment 205, the destination environment 210 or both, may be an example of a storage system with built-in data management. The source environment 205 and the destination environment 210 may serve multiple users with a single instance of software. However, other types of systems may be implemented, including—but not limited to—client-server systems, mobile device systems, and mobile network systems. The source environment 205 and the destination environment 210 may be part of an integrated data management and storage system including an application server. The application server may represent a unified storage system even though numerous storage nodes may be connected together and the number of connected storage nodes may change over time as storage nodes are added or removed.

In some examples, the cache manager 215 included in the destination environment 210 may initiate the push-based caching of metadata by transmitting a synchronization request 250 to the source environment 205. In some examples, the synchronization request 250 may include a request to synchronize metadata for one or more applications from the source environment 205 to the destination environment 210. The destination environment 210 is configured to locally cache the metadata for the one or more applications running at the source environment 205. The request may include configuration information indicating one or more filtering parameters for filtering a data stream including a set of data records at the source environment 205 to identify a subset of the set of data records and a start time and a stop time for pushing data to the destination environment 210. For example, the synchronization request 250 may indicate a start time for the source environment 205 to initiate pushing metadata to the destination environment 210. Additionally, or alternatively, the synchronization request 250 may indicate one or more column indicators for filtering the data stream according to the one or more column indicators. The source environment 205, upon receiving the request, may filter metadata according to the one or more column indicators prior to pushing the metadata 245 to the destination environment 210.

In some examples, the synchronization request 250 may include or otherwise indicate a query language filter for filtering the data stream according to the query language filter. The source environment 205 may filter the metadata from the data store 225 in accordance with the synchronization request 250. The communication client 240 may then transmit the filtered metadata 245 to the destination environment 210. The destination environment 210 may thus receive, from the source environment 205, a subset of the set of data records based on the configuration information included in the synchronization request 250. As described herein, the subset of the set of data records are determined from a filtering operation of the data stream at the source environment 205 in accordance with the one or more filtering parameters.

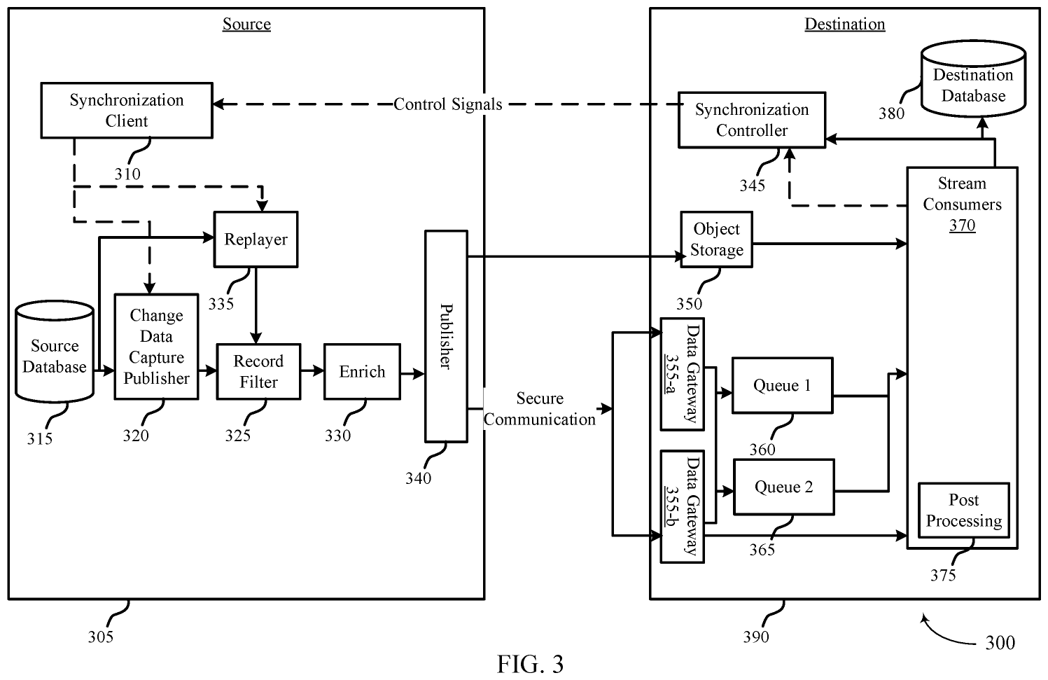

FIG. 3 shows an example of a computing environment 300 that supports techniques for real-time synchronization of metadata in accordance with aspects of the present disclosure. The computing environment 300 may include a source 305 and a destination 390. The source 305 may be an example of source environment 205 as described with reference to FIG. 2. The destination 390 may be an example of destination environment 210 as described with reference to FIG. 2.

The source 305 and the destination 390 may support near real-time synchronization of metadata in accordance with a push based model. According to aspects depicted herein, applications may run in multiple data centers and cloud environments. To access metadata of applications running in a different environment, the data can either be fetched synchronously or cached locally. Caching the metadata of an application running in a different environment locally has performance advantages. Post-processing may also be performed whenever data in the local cache changes. In some examples, caching can either be pull-based where data from each data center is pulled periodically or push-based where every data center pushes the changes as they happen. A pull-based model may suffer from the staleness of data up to the polling interval. Hence a push-based model that can sync changes in near real-time may have certain advantages over the pull-based model.

According to one or more aspects depicted herein, the source 305 and the destination 390 may support a push-based near real-time mechanism to be able to synchronize metadata across applications running in different data centers or cloud environments. This source 305 and the destination 390 may also support approaches that can be taken to ensure updates, inserts, and deletes are synchronized from the source 305 to the destination 390. The techniques depicted herein allows the source 305 to filter out certain records and enrich the records before sending them to the destination 390. This design also provides for ensuring that a row may not roll back in time even in the presence of clock jumps. Thus, the techniques depicted in FIG. 3 may be able to detect any synchronization backlogs and automatically recover from them.

The source 305 and the destination 390 may support near real-time push-based caching mechanism using a design that synchronizes changes in near real-time from any number of metadata sources in a performant and scalable manner. The design may support data addition, updating, and deletion. Additionally, or alternatively, the source 305 and the destination 390 may support filtering and enrichment of data by sources before pushing the metadata from the source 305 to the destination 390. In some examples, the source 305 and the destination 390 may support for different priorities and isolation among data streams. In some examples, the metadata backup may be scheduled in accordance with an internal clock. The techniques depicted herein ensures that a data row may not roll back in time even if there are clock skews between the source 305 and the destination 390. Thus, the source 305 and the destination 390 depicted in FIG. 3 supports automatic detection of synchronization backlog and recovery.

According to one or more aspects of the present disclosure, the source 305 and the destination 390 may support a push-based near real-time mechanism to synchronize metadata between the source 305 and the destination 390. Although a single source 305 is depicted in FIG. 3, it is to be understood that multiple sources may be supported for a single destination. The method of push-based near real-time synchronization of metadata leverages a change data capture operation at source databases to track any insert/update/delete operations on the data tables.

As depicted in the example of FIG. 3, the source 305 may include a synchronization client 310 which may be in communication with a synchronization controller 345 included in the destination 390. The synchronization client 310 may receive control signals from the synchronization controller 345. The source database 315 may identify any updates to the data. The source database 315 may transmit the update information (e.g., insert/update/delete) to a change data capture publisher 320. The change data capture publisher 320 may publish each change data capture record to the destination 390 where consumers store it in the destination's database. In some examples, the destination 390 may push configuration information to each source such as when to start/stop pushing data, or any filtering to be done on the data. For example, the destination 390 may transmit to the source 305 configured to run one or more applications, a request to synchronize metadata for the one or more applications from the source 305 to the destination 390. In some examples, the destination 390 may be configured to locally cache the metadata for the one or more applications. The request may be included in the control signals transmitted from the synchronization controller 345. The request may include configuration information indicating one or more filtering parameters for filtering a data stream including a set of data records at the source 305 to identify a subset of the set of data records and a start time and a stop time for pushing data to the destination 390.

In some examples, the destination 390 may not request synchronization of every change happening at the source 305. To avoid receiving unnecessary data, the destination 390 may provide some filter conditions to the source 305. In some examples, the record filter 325 at the source 305 may implement the one or more filtering parameters to identify a subset of data records to push to the destination 390 for back up. In some examples, the record filter 325 at the source 305 may choose to drop certain class of updates. In some examples, the one or more filtering parameters may include one or more column indicators for filtering the data stream according to the one or more column indicators. The source 305 may filter the subset of the set of data records based on determining that one or more rows corresponding to the one or more column indicators have changed at the source 305. For example, the one or more filtering parameters may include a RelevantColumnFilter indicating one or more column identifiers. The destination 390 may use the one or more column identifiers to request that the source 305 only propagates a row if these columns have changed. Additionally, or alternatively, the one or more filtering parameters may include a query language filter (e.g., SQLFilter) for filtering the data stream according to the query language filter. The source 305, upon receiving the indication of the query language filter, may propagate a row if it matches the given query language (e.g., SQL). The record filter 325 may receive additional information from replayer 335.

In some examples, the source 305 may use the enrich component 330 to modify data records prior to pushing them to the destination 390. In some examples, the source 305 may transform the data records before sending to the destination 390. For example, an “event” record can be enriched with information about the object associated with the event. In some examples, the source 305 and the destination 390 may support different types of enrichments including projection of columns, transformation of individual columns, and addition of columns. In some examples, the destination may transmit an enrichment request for the source 305 to modify a set of data records after filtering the data stream and prior to transmitting the subset of the set of data records from the source 305. In some examples, the subset of the set of data records may include the modified set of data records. The enrichment request may indicate a selection of a subset of columns from a table included in the set of data records. For instance, the destination 390 may only select a subset of columns from a table. Upon receiving such an enrichment request, the source 305 may select the subset of columns from the table and transmit the subset of columns to the destination 390. Additionally, or alternatively, the enrichment request may include a request to transform a value of a column associated with a data record based on applying a function. For example, upon receiving the enrichment request, the source 305 may transform a value of a column by applying a function to it. This function may take other columns from the same record as its closure. In some examples, the enrichment request may include a request to combine data across a set of tables included in the set of data records. Upon receiving such an enrichment request, the source 305 may poll channels may create the resultant record by combining data across multiple tables and by adding data that is generated programmatically.

In some examples, the source 305 and the destination 390 may have a consistent data view across multiple tables can by using one or more queries (e.g., “AS OF SYSTEM TIME” queries) to get the version of the row at the specific point in time as of the change data capture record. As depicted in the example of FIG. 3, every record generated by change data capture publisher 320 may be transmitted to the record filter 325, where certain records may be dropped. The filtering may involve inspecting the record. After filtering, the records may be passed through different enrichers (via enrich component 330) where they may be transformed. Some enrichment operations may be slower than others, hence there can be multiple enricher groups depending on the latency of each enricher. After enrichment, the source 305 may transmit the data records to a destination queue at the publisher 340. There can be multiple publishers running in parallel. Due to parallelism, the records may not be published in the same order as they were generated. The publisher 340 may transmit the data records using secure communications. Additionally, or alternatively, the publisher 340 may transmit the data records to the object storage 350. In some examples, the source 305 may store a subset of data records in a data queue associated with the source 305. Additionally, or alternatively, the destination 390 may also maintain one or more data queues. The computing environment 300 may support using separate queues to achieve isolation among data sources as messages from one data source won't get mixed with other data sources.

The destination 390 may maintain multiple queues for the incoming data records. For examples, the queues (e.g., queue 1 360 and queue 2 365) at the destination 390 may make consumers and producers independently scalable. A data record pushed from the source may be transmitted to the destination 390 via a data gateway (e.g., data gateway 335-a or data gateway 355-b). The data record may then be admitted to a queue. There can be one queue for each data source and use case to provide better isolation and prioritization. For example, in case any source starts sending a lot of updates, it won't affect the consumption of the other sources as every source has its own queue. In some examples, each queue may be responsible for storing the update in the database. The number of resources for any queue can be configurable to provide higher or lower priority for data sources. Upon receiving the data, the data record may be forwarded to stream consumers 370 for post processing 375. Additionally, or alternatively, the data records (prior to or after post processing) may be stored in the destination database 380.

When pushing data records, the source 305 may ensure that each row in the source 305 has an update timestamp, which may be a standard time on the source. The standard time may be based on a time source library common to both the source 305 and the destination 390. Each row in the queue may be iterated over and the source 305 may check to determine whether a particular row needs to be updated in the destination 390. For example, if the source 305 determines that an operation type is insert and the row does not exist in the destination 390, then the source 305 may choose to insert it. Additionally, or alternatively, if the source determines that an operation type is update, then the source 305 inserts the row if the row does not exist in the destination 390. In some examples, if the source 305 determines that the row exists, then the source may update the row with an updated standard if the update time of the row is newer than that of the destination 390. If the source determines that an operation type is delete, then the source 305 may choose to delete the row in the destination 390 if the update time of the row is newer than that of the destination 390.

In some examples, the destination 390 may determine whether any data source is lagging in pushing updates, For example, the destination 390 may implement checkpoints to determine whether any data source is lagging in pushing updates. In some examples, the change data capture publisher 320 may send a checkpoint for a table every interval indicating that all data up to a point in time has been sent for that table. The change data capture publisher 320 may send information on checkpoints irrespective of whether or not any record is to be published. In some examples, the destination 390 may keep track of all the checkpoints consumed for a source 305. If the latest checkpoint is older than some threshold (e.g., 5 minutes), the destination 390 may infer that the source 305 is backlogged. Additionally, or alternatively, if the destination 390 detects a backlog at the source 305, then the destination 390 may trigger a replay (via replayer 335) to recover from the backlog. For example, the replay may help catch up with the backlog by publishing the rows directly from the database (bypassing change data capture).

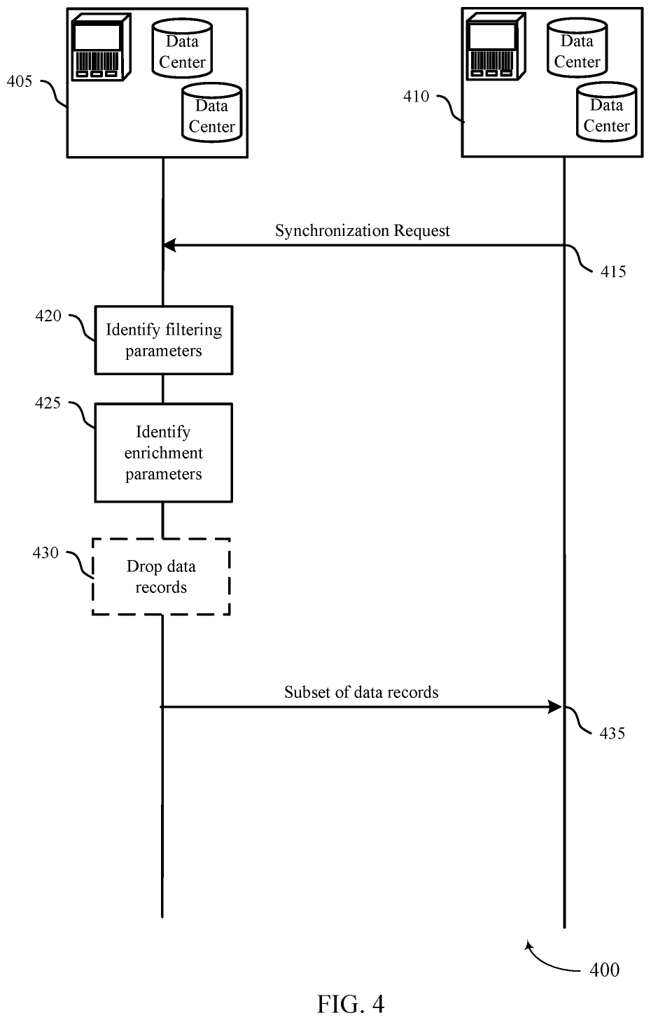

FIG. 4 shows an example of a process flow 400 that supports techniques for real-time synchronization of metadata in accordance with aspects of the present disclosure. The process flow 400 includes a data management system including a source data storage environment 405 and a destination data storage environment 410. The source data storage environment 405 and the destination data storage environment 410 may include an application server, and multiple data centers of a computing cluster as described with respect to FIGS. 1 and 2. Although a single entity is depicted as the source data storage environment 405 and the destination data storage environment 410, it may be understood that components of the source data storage environment 405 and the destination data storage environment 410 may be located in different locations. The source data storage environment 405 and the destination data storage environment 410 may support a push-based caching operation. The source data storage environment 405 may be configured to run one or more applications.

In some examples, the operations illustrated in the process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 415, the source data storage environment 405 may receive a request to synchronize metadata for the one or more applications from the source data storage environment 405 to the destination data storage environment 410. In some examples, the destination data storage environment 415 may be configured to locally cache the metadata for the one or more applications. The request may include configuration information indicating one or more filtering parameters for filtering a data stream including a set of data records at the source data storage environment 405 to identify a subset of the set of data records and a start time and a stop time for pushing data to the destination data storage environment 410.

At 420, the source data storage environment 405 may identify one or more filtering parameters. In some examples, the one or more filtering parameters may include one or more column indicators for filtering the data stream according to the one or more column indicators. Additionally, or alternatively, the one or more filtering parameters may include a query language filter for filtering the data stream according to the query language filter.

At 425, the source data storage environment 405 may identify one or more enrichment parameters from an enrichment request received form the destination data storage environment 410. In some examples, the enrichment request may indicate a selection of a subset of columns from a table included in the set of data records. In some examples, the enrichment request may include a request to transform a value of a column associated with a data record based on applying a function. Additionally, or alternatively, the enrichment request may include a request to combine data across a set of tables included in the set of data records.

At 430, the source data storage environment 405 may optionally drop one or more data records after filtering the data stream including the set of data records and prior to transmitting the subset of the set of data records to the destination data storage environment 410.

At 435, the source data storage environment 405 may transmit the subset of the set of data records based on the configuration information. In some examples, the subset of the set of data records may be determined from a filtering operation of the data stream at the source data storage environment 405 in accordance with the one or more filtering parameters.

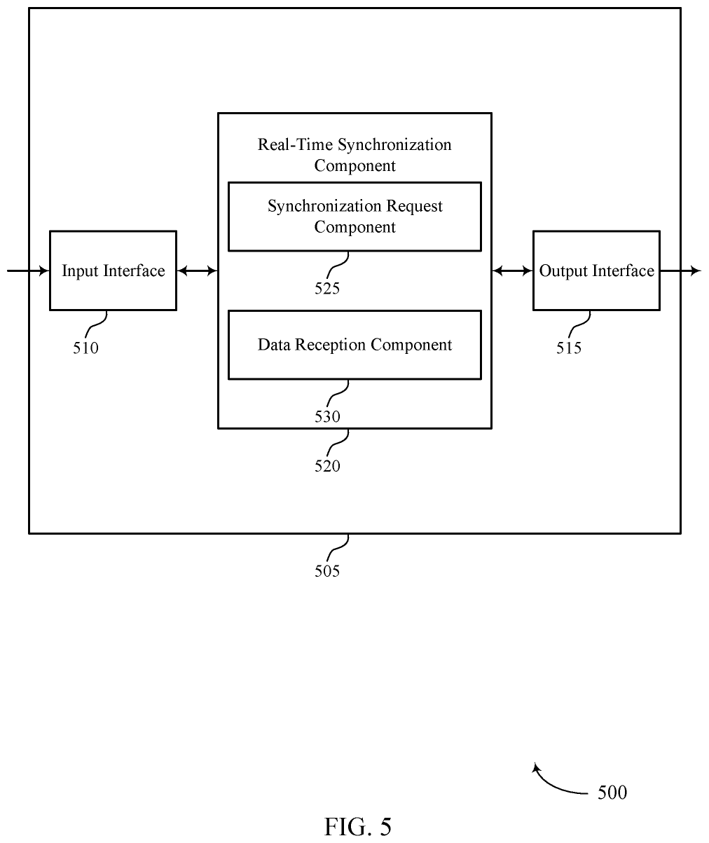

FIG. 5 shows a block diagram 500 of a system 505 that supports techniques for real-time synchronization of metadata in accordance with aspects of the present disclosure. In some examples, the system 505 may be an example of aspects of one or more components described with reference to FIG. 1, such as a DMS 110. The system 505 may include an input interface 510, an output interface 515, and a real-time synchronization component 520. The system 505 may also include one or more processors. Each of these components may be in communication with one another (e.g., via one or more buses, communications links, communications interfaces, or any combination thereof).

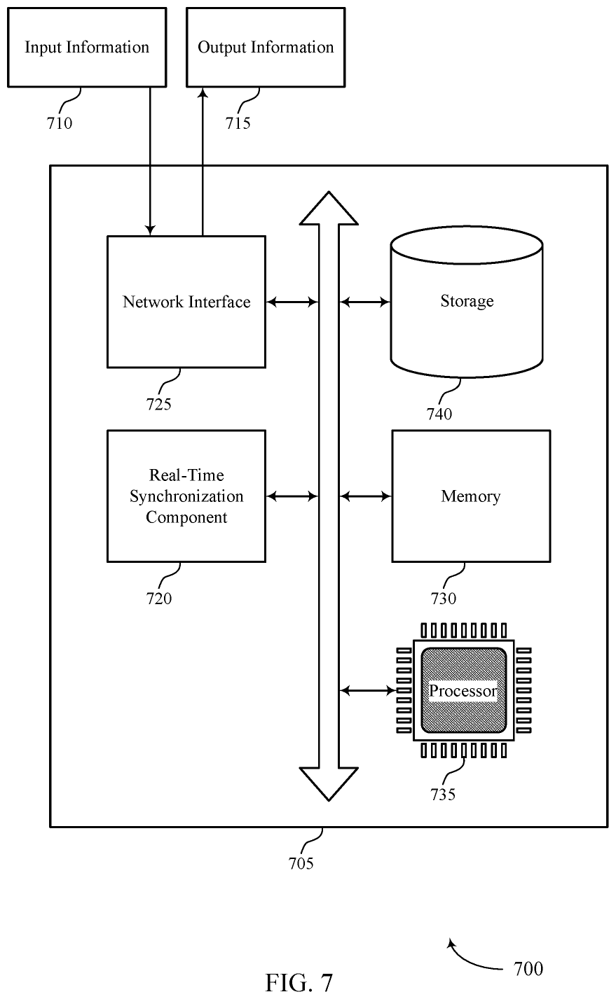

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the real-time synchronization component 520 to support techniques for real-time synchronization of metadata. In some cases, the input interface 510 may be a component of a network interface 725 as described with reference to FIG. 7.

The output interface 515 may manage output signaling for the system 505. For example, the output interface 515 may receive signaling from other components of the system 505, such as the real-time synchronization component 520, and may transmit such output signaling corresponding to (e.g., representative of or otherwise based on) such signaling to other systems or devices. In some cases, the output interface 515 may be a component of a network interface 725 as described with reference to FIG. 7.

For example, the real-time synchronization component 520 may include a synchronization request component 525 a data reception component 530, or any combination thereof. In some examples, the real-time synchronization component 520, or various components thereof, may be configured to perform various operations (e.g., receiving, monitoring, transmitting) using or otherwise in cooperation with the input interface 510, the output interface 515, or both. For example, the real-time synchronization component 520 may receive information from the input interface 510, send information to the output interface 515, or be integrated in combination with the input interface 510, the output interface 515, or both to receive information, transmit information, or perform various other operations as described herein.

The real-time synchronization component 520 may support a push-based caching operation at a destination data storage environment of a data management system in accordance with examples as disclosed herein. The synchronization request component 525 may be configured as or otherwise support a means for transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The data reception component 530 may be configured as or otherwise support a means for receiving, from the source data storage environment, the subset of the set of multiple data records based on the configuration information, where the subset of the set of multiple data records are determined from a filtering operation of the data stream at the source data storage environment in accordance with the one or more filtering parameters.

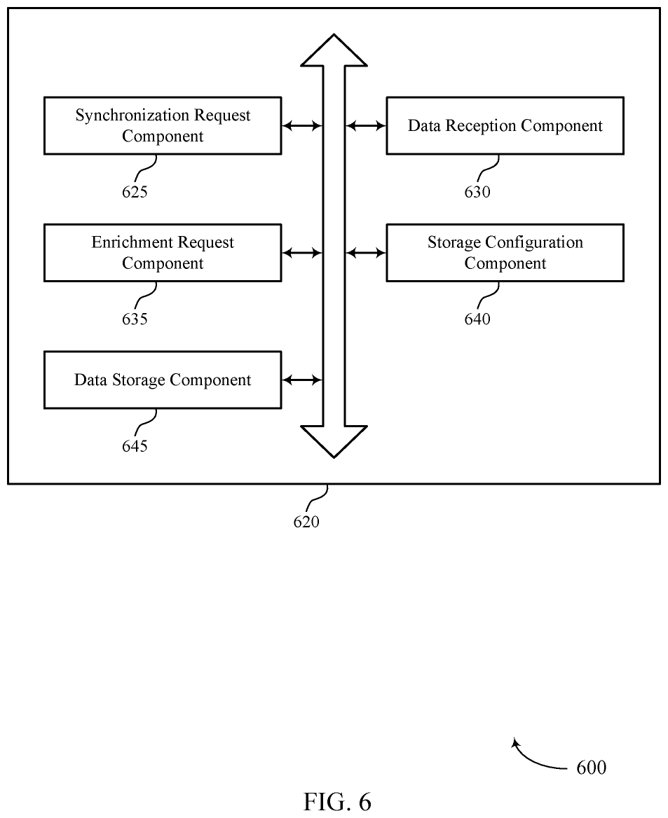

FIG. 6 shows a block diagram 600 of a real-time synchronization component 620 that supports techniques for real-time synchronization of metadata in accordance with aspects of the present disclosure. The real-time synchronization component 620 may be an example of aspects of a real-time synchronization component or a real-time synchronization component 520, or both, as described herein. The real-time synchronization component 620, or various components thereof, may be an example of means for performing various aspects of techniques for real-time synchronization of metadata as described herein. For example, the real-time synchronization component 620 may include a synchronization request component 625, a data reception component 630, an enrichment request component 635, a storage configuration component 640, a data storage component 645, or any combination thereof. Each of these components may communicate, directly or indirectly, with one another (e.g., via one or more buses, communications links, communications interfaces, or any combination thereof).

The real-time synchronization component 620 may support a push-based caching operation at a destination data storage environment of a data management system in accordance with examples as disclosed herein. The synchronization request component 625 may be configured as or otherwise support a means for transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The data reception component 630 may be configured as or otherwise support a means for receiving, from the source data storage environment, the subset of the set of multiple data records based on the configuration information, where the subset of the set of multiple data records are determined from a filtering operation of the data stream at the source data storage environment in accordance with the one or more filtering parameters.

In some examples, to support transmitting the request, the synchronization request component 625 may be configured as or otherwise support a means for transmitting the one or more filtering parameters including one or more column indicators for filtering the data stream according to the one or more column indicators, where the subset of the set of multiple data records are received based on determining that one or more rows corresponding to the one or more column indicators have changed at the source data storage environment.

In some examples, to support transmitting the request, the synchronization request component 625 may be configured as or otherwise support a means for transmitting the one or more filtering parameters including a query language filter for filtering the data stream according to the query language filter, where the subset of the set of multiple data records are received based on determining that one or more rows correspond to the query language filter at the source data storage environment.

In some examples, to support transmitting the request, the enrichment request component 635 may be configured as or otherwise support a means for transmitting an enrichment request to modify a set of data records after filtering the data stream and prior to receiving the subset of the set of multiple data records from the source data storage environment, where the subset of the set of multiple data records includes the modified set of data records.

In some examples, the enrichment request indicates a selection of a subset of columns from a table included in the set of multiple data records. In some examples, the subset of the set of multiple data records includes data corresponding to the subset of columns included in the table.

In some examples, the enrichment request includes a request to transform a value of a column associated with a data record based on applying a function. In some examples, the subset of the set of multiple data records includes data corresponding to the transformed value of the column associated with a data record.

In some examples, the enrichment request includes a request to combine data across a set of multiple tables included in the set of multiple data records. In some examples, the subset of the set of multiple data records includes data combined across the set of multiple tables included in the set of multiple data records.

In some examples, the storage configuration component 640 may be configured as or otherwise support a means for configuring the source data storage environment to drop one or more data records after filtering the data stream including the set of multiple data records and prior to transmitting the subset of the set of multiple data records to the destination data storage environment.

In some examples, the data storage component 645 may be configured as or otherwise support a means for storing the subset of the set of multiple data records in a data queue associated with the source data storage environment.

In some examples, each data record of the set of multiple data records corresponds to a timestamp associated with a time source library common to the source data storage environment and the destination data storage environment.

FIG. 7 shows a block diagram 700 of a system 705 that supports techniques for real-time synchronization of metadata in accordance with aspects of the present disclosure. The system 705 may be an example of or include the components of a system 505 as described herein. The system 705 may include components for data management, including components such as a real-time synchronization component 720, an input information 710, an output information 715, a network interface 725, a memory 730, a processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting techniques for real-time synchronization of metadata). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

The real-time synchronization component 720 may support a push-based caching operation at a destination data storage environment of a data management system in accordance with examples as disclosed herein. For example, the real-time synchronization component 720 may be configured as or otherwise support a means for transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The real-time synchronization component 720 may be configured as or otherwise support a means for receiving, from the source data storage environment, the subset of the set of multiple data records based on the configuration information, where the subset of the set of multiple data records are determined from a filtering operation of the data stream at the source data storage environment in accordance with the one or more filtering parameters.

By including or configuring the real-time synchronization component 720 in accordance with examples as described herein, the system 705 may support techniques for techniques for real-time synchronization of metadata, which may provide one or more benefits such as, for example, improved synchronization between source data storage and target data storage, among other possibilities.

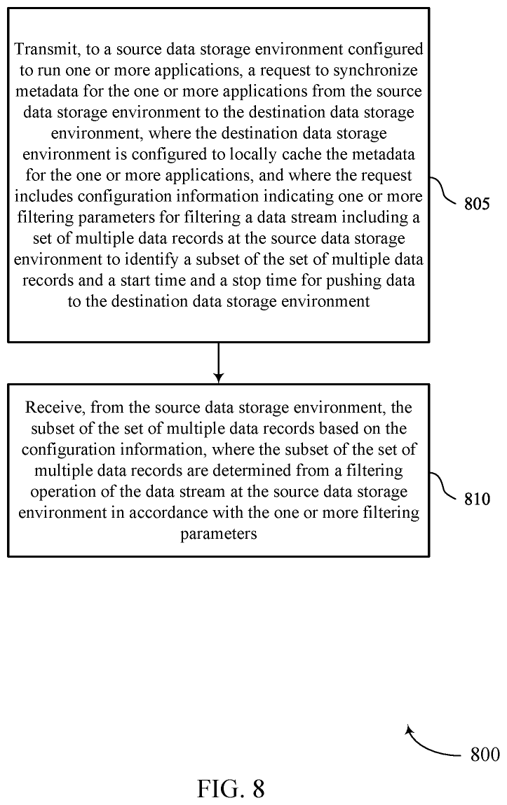

FIG. 8 shows a flowchart illustrating a method 800 that supports techniques for real-time synchronization of metadata in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The operations of 805 may be performed in accordance with examples as disclosed herein. In some examples, aspects of the operations of 805 may be performed by a synchronization request component 625 as described with reference to FIG. 6.

At 810, the method may include receiving, from the source data storage environment, the subset of the set of multiple data records based on the configuration information, where the subset of the set of multiple data records are determined from a filtering operation of the data stream at the source data storage environment in accordance with the one or more filtering parameters. The operations of 810 may be performed in accordance with examples as disclosed herein. In some examples, aspects of the operations of 810 may be performed by a data reception component 630 as described with reference to FIG. 6.

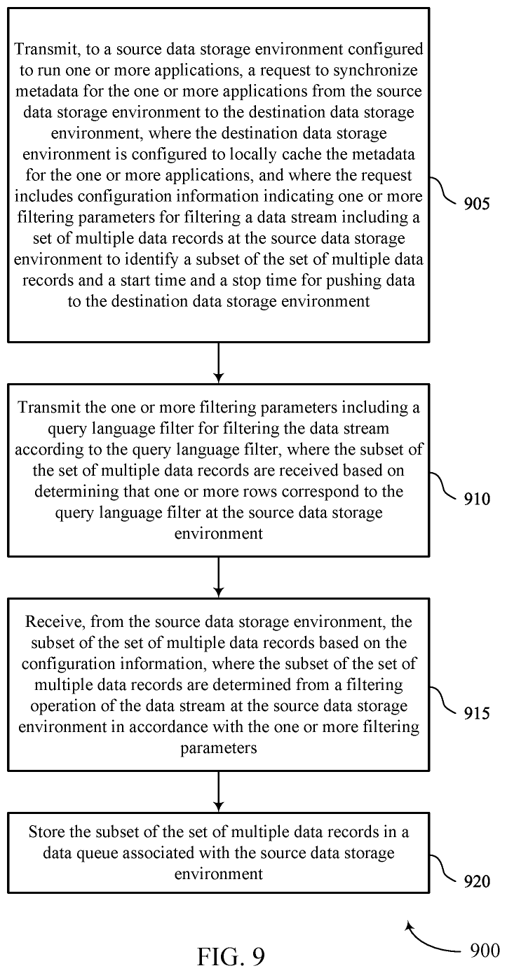

FIG. 9 shows a flowchart illustrating a method 900 that supports techniques for real-time synchronization of metadata in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The operations of 905 may be performed in accordance with examples as disclosed herein. In some examples, aspects of the operations of 905 may be performed by a synchronization request component 625 as described with reference to FIG. 6.

At 910, the method may include transmitting the one or more filtering parameters including a query language filter for filtering the data stream according to the query language filter, where the subset of the set of multiple data records are received based on determining that one or more rows correspond to the query language filter at the source data storage environment. The operations of 910 may be performed in accordance with examples as disclosed herein. In some examples, aspects of the operations of 910 may be performed by a synchronization request component 625 as described with reference to FIG. 6.

At 915, the method may include receiving, from the source data storage environment, the subset of the set of multiple data records based on the configuration information, where the subset of the set of multiple data records are determined from a filtering operation of the data stream at the source data storage environment in accordance with the one or more filtering parameters. The operations of 915 may be performed in accordance with examples as disclosed herein. In some examples, aspects of the operations of 915 may be performed by a data reception component 630 as described with reference to FIG. 6.

At 920, the method may include storing the subset of the set of multiple data records in a data queue associated with the source data storage environment. The operations of 920 may be performed in accordance with examples as disclosed herein. In some examples, aspects of the operations of 920 may be performed by a data storage component 645 as described with reference to FIG. 6.

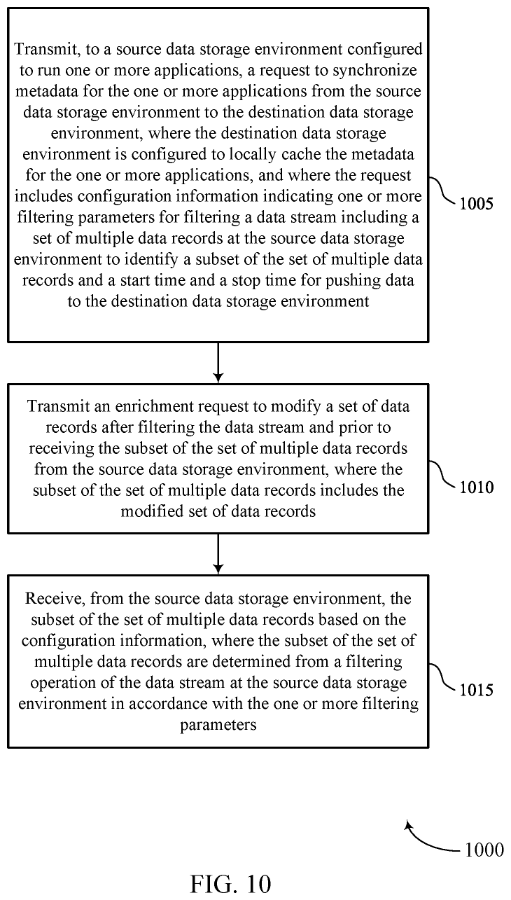

FIG. 10 shows a flowchart illustrating a method 1000 that supports techniques for real-time synchronization of metadata in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The operations of 1005 may be performed in accordance with examples as disclosed herein. In some examples, aspects of the operations of 1005 may be performed by a synchronization request component 625 as described with reference to FIG. 6.

At 1010, the method may include transmitting an enrichment request to modify a set of data records after filtering the data stream and prior to receiving the subset of the set of multiple data records from the source data storage environment, where the subset of the set of multiple data records includes the modified set of data records. The operations of 1010 may be performed in accordance with examples as disclosed herein. In some examples, aspects of the operations of 1010 may be performed by an enrichment request component 635 as described with reference to FIG. 6.

At 1015, the method may include receiving, from the source data storage environment, the subset of the set of multiple data records based on the configuration information, where the subset of the set of multiple data records are determined from a filtering operation of the data stream at the source data storage environment in accordance with the one or more filtering parameters. The operations of 1015 may be performed in accordance with examples as disclosed herein. In some examples, aspects of the operations of 1015 may be performed by a data reception component 630 as described with reference to FIG. 6.

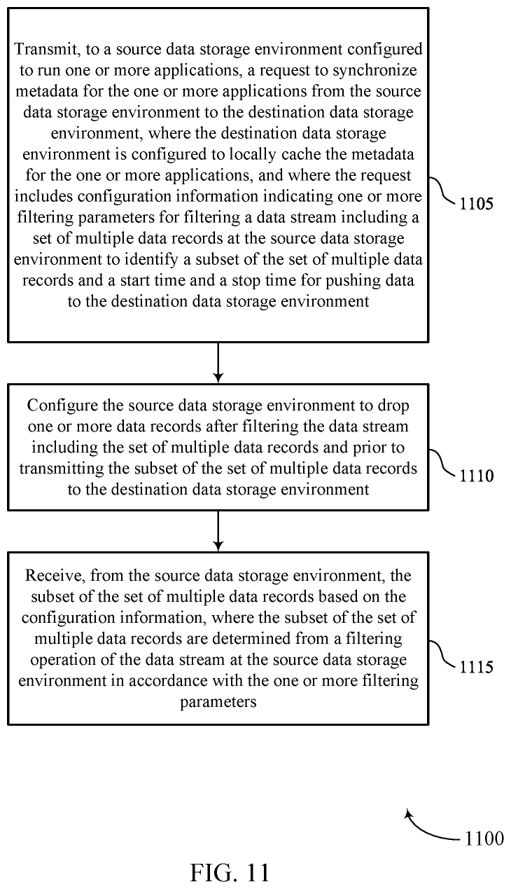

FIG. 11 shows a flowchart illustrating a method 1100 that supports techniques for real-time synchronization of metadata in accordance with aspects of the present disclosure. The operations of the method 1100 may be implemented by a DMS or its components as described herein. For example, the operations of the method 1100 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1105, the method may include transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment. The operations of 1105 may be performed in accordance with examples as disclosed herein. In some examples, aspects of the operations of 1105 may be performed by a synchronization request component 625 as described with reference to FIG. 6.

At 1110, the method may include configuring the source data storage environment to drop one or more data records after filtering the data stream including the set of multiple data records and prior to transmitting the subset of the set of multiple data records to the destination data storage environment. The operations of 1110 may be performed in accordance with examples as disclosed herein. In some examples, aspects of the operations of 1110 may be performed by a storage configuration component 640 as described with reference to FIG. 6.

At 1115, the method may include receiving, from the source data storage environment, the subset of the set of multiple data records based on the configuration information, where the subset of the set of multiple data records are determined from a filtering operation of the data stream at the source data storage environment in accordance with the one or more filtering parameters. The operations of 1115 may be performed in accordance with examples as disclosed herein. In some examples, aspects of the operations of 1115 may be performed by a data reception component 630 as described with reference to FIG. 6.

A method for a push-based caching operation at a destination data storage environment of a data management system is described. The method may include transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment and receiving, from the source data storage environment, the subset of the set of multiple data records based on the configuration information, where the subset of the set of multiple data records are determined from a filtering operation of the data stream at the source data storage environment in accordance with the one or more filtering parameters.

An apparatus for a push-based caching operation at a destination data storage environment of a data management system is described. The apparatus may include a processor, memory coupled with the processor, and instructions stored in the memory. The instructions may be executable by the processor to cause the apparatus to transmit, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment and receive, from the source data storage environment, the subset of the set of multiple data records based on the configuration information, where the subset of the set of multiple data records are determined from a filtering operation of the data stream at the source data storage environment in accordance with the one or more filtering parameters.

Another apparatus for a push-based caching operation at a destination data storage environment of a data management system is described. The apparatus may include means for transmitting, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment and means for receiving, from the source data storage environment, the subset of the set of multiple data records based on the configuration information, where the subset of the set of multiple data records are determined from a filtering operation of the data stream at the source data storage environment in accordance with the one or more filtering parameters.

A non-transitory computer-readable medium storing code for a push-based caching operation at a destination data storage environment of a data management system is described. The code may include instructions executable by a processor to transmit, to a source data storage environment configured to run one or more applications, a request to synchronize metadata for the one or more applications from the source data storage environment to the destination data storage environment, where the destination data storage environment is configured to locally cache the metadata for the one or more applications, and where the request includes configuration information indicating one or more filtering parameters for filtering a data stream including a set of multiple data records at the source data storage environment to identify a subset of the set of multiple data records and a start time and a stop time for pushing data to the destination data storage environment and receive, from the source data storage environment, the subset of the set of multiple data records based on the configuration information, where the subset of the set of multiple data records are determined from a filtering operation of the data stream at the source data storage environment in accordance with the one or more filtering parameters.

In some examples of the method, apparatuses, and non-transitory computer-readable medium described herein, transmitting the request may include operations, features, means, or instructions for transmitting the one or more filtering parameters including one or more column indicators for filtering the data stream according to the one or more column indicators, where the subset of the set of multiple data records may be received based on determining that one or more rows corresponding to the one or more column indicators may have changed at the source data storage environment.

In some examples of the method, apparatuses, and non-transitory computer-readable medium described herein, transmitting the request may include operations, features, means, or instructions for transmitting the one or more filtering parameters including a query language filter for filtering the data stream according to the query language filter, where the subset of the set of multiple data records may be received based on determining that one or more rows correspond to the query language filter at the source data storage environment.

In some examples of the method, apparatuses, and non-transitory computer-readable medium described herein, transmitting the request may include operations, features, means, or instructions for transmitting an enrichment request to modify a set of data records after filtering the data stream and prior to receiving the subset of the set of multiple data records from the source data storage environment, where the subset of the set of multiple data records includes the modified set of data records.

In some examples of the method, apparatuses, and non-transitory computer-readable medium described herein, the enrichment request indicates a selection of a subset of columns from a table included in the set of multiple data records and the subset of the set of multiple data records includes data corresponding to the subset of columns included in the table.

In some examples of the method, apparatuses, and non-transitory computer-readable medium described herein, the enrichment request includes a request to transform a value of a column associated with a data record based on applying a function and the subset of the set of multiple data records includes data corresponding to the transformed value of the column associated with a data record.

In some examples of the method, apparatuses, and non-transitory computer-readable medium described herein, the enrichment request includes a request to combine data across a set of multiple tables included in the set of multiple data records and the subset of the set of multiple data records includes data combined across the set of multiple tables included in the set of multiple data records.

Some examples of the method, apparatuses, and non-transitory computer-readable medium described herein may further include operations, features, means, or instructions for configuring the source data storage environment to drop one or more data records after filtering the data stream including the set of multiple data records and prior to transmitting the subset of the set of multiple data records to the destination data storage environment.

Some examples of the method, apparatuses, and non-transitory computer-readable medium described herein may further include operations, features, means, or instructions for storing the subset of the set of multiple data records in a data queue associated with the source data storage environment.

In some examples of the method, apparatuses, and non-transitory computer-readable medium described herein, each data record of the set of multiple data records corresponds to a timestamp associated with a time source library common to the source data storage environment and the destination data storage environment.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for a push-based caching operation at a destination data storage environment of a data management system, comprising:
transmitting, to a source data storage environment configured to run one or more applications, a request to synchronize metadata for the one or more applications from the source data storage environment to the destination data storage environment, wherein the destination data storage environment is configured to locally cache the metadata for the one or more applications, and wherein the request comprises configuration information indicating one or more filtering parameters for filtering a data stream comprising a plurality of data records at the source data storage environment to identify a subset of the plurality of data records and a start time and a stop time for pushing data to the destination data storage environment; and
receiving, from the source data storage environment, the subset of the plurality of data records based at least in part on the configuration information, wherein the subset of the plurality of data records are determined from a filtering operation of the data stream at the source data storage environment in accordance with the one or more filtering parameters.

2. The method of claim 1, wherein transmitting the request further comprises:
transmitting the one or more filtering parameters comprising one or more column indicators for filtering the data stream according to the one or more column indicators, wherein the subset of the plurality of data records are received based at least in part on determining that one or more rows corresponding to the one or more column indicators have changed at the source data storage environment.

3. The method of claim 1, wherein transmitting the request further comprises:
transmitting the one or more filtering parameters comprising a query language filter for filtering the data stream according to the query language filter, wherein the subset of the plurality of data records are received based at least in part on determining that one or more rows correspond to the query language filter at the source data storage environment.

4. The method of claim 1, wherein transmitting the request further comprises:
transmitting an enrichment request to modify a set of data records after filtering the data stream and prior to receiving the subset of the plurality of data records from the source data storage environment, wherein the subset of the plurality of data records comprises the modified set of data records.

5. The method of claim 4, wherein the enrichment request indicates a selection of a subset of columns from a table included in the plurality of data records, and the subset of the plurality of data records comprises data corresponding to the subset of columns included in the table.

6. The method of claim 4, wherein the enrichment request comprises a request to transform a value of a column associated with a data record based at least in part on applying a function, and the subset of the plurality of data records comprises data corresponding to the transformed value of the column associated with a data record.

7. The method of claim 4, wherein the enrichment request comprises a request to combine data across a plurality of tables included in the plurality of data records, and the subset of the plurality of data records comprises data combined across the plurality of tables included in the plurality of data records.

8. The method of claim 1, further comprising:
configuring the source data storage environment to drop one or more data records after filtering the data stream comprising the plurality of data records and prior to transmitting the subset of the plurality of data records to the destination data storage environment.

9. The method of claim 1, further comprising:
storing the subset of the plurality of data records in a data queue associated with the source data storage environment.

10. The method of claim 1, wherein each data record of the plurality of data records corresponds to a timestamp associated with a time source library common to the source data storage environment and the destination data storage environment.

11. An apparatus for a push-based caching operation at a destination data storage environment of a data management system, comprising:
a processor;
memory coupled with the processor; and
instructions stored in the memory and executable by the processor to cause the apparatus to:
transmit, to a source data storage environment configured to run one or more applications, a request to synchronize metadata for the one or more applications from the source data storage environment to the destination data storage environment, wherein the destination data storage environment is configured to locally cache the metadata for the one or more applications, and wherein the request comprises configuration information indicating one or more filtering parameters for filtering a data stream comprising a plurality of data records at the source data storage environment to identify a subset of the plurality of data records and a start time and a stop time for pushing data to the destination data storage environment; and
receive, from the source data storage environment, the subset of the plurality of data records based at least in part on the configuration information, wherein the subset of the plurality of data records are determined from a filtering operation of the data stream at the source data storage environment in accordance with the one or more filtering parameters.

12. The apparatus of claim 11, wherein the instructions to transmit the request are further executable by the processor to cause the apparatus to:
transmit the one or more filtering parameters comprising one or more column indicators for filtering the data stream according to the one or more column indicators, wherein the subset of the plurality of data records are received based at least in part on determining that one or more rows corresponding to the one or more column indicators have changed at the source data storage environment.

13. The apparatus of claim 11, wherein the instructions to transmit the request are further executable by the processor to cause the apparatus to:
transmit the one or more filtering parameters comprising a query language filter for filtering the data stream according to the query language filter, wherein the subset of the plurality of data records are received based at least in part on determining that one or more rows correspond to the query language filter at the source data storage environment.

14. The apparatus of claim 11, wherein the instructions to transmit the request are further executable by the processor to cause the apparatus to:
transmit an enrichment request to modify a set of data records after filtering the data stream and prior to receiving the subset of the plurality of data records from the source data storage environment, wherein the subset of the plurality of data records comprises the modified set of data records.

15. The apparatus of claim 14, wherein the enrichment request indicates a selection of a subset of columns from a table included in the plurality of data records, and the subset of the plurality of data records comprises data corresponding to the subset of columns included in the table.

16. The apparatus of claim 14, wherein the enrichment request comprises a request to transform a value of a column associated with a data record based at least in part on applying a function, and the subset of the plurality of data records comprises data corresponding to the transformed value of the column associated with a data record.

17. The apparatus of claim 14, wherein the enrichment request comprises a request to combine data across a plurality of tables included in the plurality of data records, and the subset of the plurality of data records comprises data combined across the plurality of tables included in the plurality of data records.

18. The apparatus of claim 11, wherein the instructions are further executable by the processor to cause the apparatus to:
configure the source data storage environment to drop one or more data records after filtering the data stream comprising the plurality of data records and prior to transmitting the subset of the plurality of data records to the destination data storage environment.

19. The apparatus of claim 11, wherein the instructions are further executable by the processor to cause the apparatus to:
store the subset of the plurality of data records in a data queue associated with the source data storage environment.

20. A non-transitory computer-readable medium storing code for a push-based caching operation at a destination data storage environment of a data management system, the code comprising instructions executable by a processor to:
transmit, to a source data storage environment configured to run one or more applications, a request to synchronize metadata for the one or more applications from the source data storage environment to the destination data storage environment, wherein the destination data storage environment is configured to locally cache the metadata for the one or more applications, and wherein the request comprises configuration information indicating one or more filtering parameters for filtering a data stream comprising a plurality of data records at the source data storage environment to identify a subset of the plurality of data records and a start time and a stop time for pushing data to the destination data storage environment; and
receive, from the source data storage environment, the subset of the plurality of data records based at least in part on the configuration information, wherein the subset of the plurality of data records are determined from a filtering operation of the data stream at the source data storage environment in accordance with the one or more filtering parameters.
